(19) United States
(12) Patent Application Publication
(10) Pub. No.: US 2026/0019675 A1
(43) Pub. Date: Jan. 15, 2026

(54) MANAGING MEDIA STREAMING WITH A MACHINE-LEARNING MODEL

(71) Applicant: Sony Group Corporation, Tokyo (JP)

(72) Inventors: James R. Milne, Ramona, CA (US); William Clay, Poway, CA (US); Justin Kenefick, San Diego, CA (US); Marvin DeMerchant, San Diego, CA (US)

(73) Assignee: Sony Group Corporation, Tokyo (JP)

(21) Appl. No.: 18/773,396

(22) Filed: Jul. 15, 2024

(51) Int. Cl. H04N 21/466; H04N 21/41; H04N 21/442; H04N 21/45; H04N 21/475; H04N 21/81

(52) U.S. Cl. CPC H04N 21/4668; H04N 21/4126; H04N 21/44218; H04N 21/4532; H04N 21/4755; H04N 21/8106

(57) ABSTRACT

A method includes receiving, from a wireless device, information about a plurality of users within proximity to a media player. The method further includes determining, based on the information, user profiles associated with the plurality of users. The method further includes generating a group profile that includes the user profiles. The method further includes providing the group profile and a request for one or more media items as input to a machine-learning model. The method further includes the machine-learning model outputting the one or more media items that satisfy the request. The method further includes providing a recommendation that includes the one or more media items.

### BACKGROUND

Accessing streaming services on a television can be cumbersome due to manually typing in usernames and passwords. Some services make the process easier by providing a QR code or uniform resource locator (URL) that a user may access on a mobile device to register with the streaming service. However, this process becomes frustrating when the streaming service requires frequent authentication. One service attempts to remedy these issues by using a camera to perform facial recognition to identify a user; however, customers may be uncomfortable with the loss of privacy that occurs during facial recognition and the safety risk of storing a user's image on a server.

### SUMMARY

A method includes receiving, from a wireless device, information about a plurality of users within proximity to a media player. The method further includes determining, based on the information, user profiles associated with the plurality of users, the user profiles each including media interests. The method further includes generating group profile that includes the user profiles. The method further includes providing the group profile and a request for one or more media items as input to a machine-learning model. The method further includes the machine-learning model outputting the one or more media items that satisfy the request based on the media interests. The method further includes providing a recommendation that includes the one or more media items.

In some embodiments, each user profile further includes viewing preferences and the method further includes responsive to a user selecting a media item from the one or more media items in the recommendation, instructing the media player to play selected media item; providing, as input to the machine-learning model, a request to determine an action and for instructions to perform the action to improve a viewing experience in a room; outputting, with the machine-learning model and based on the viewing preferences, instructions to perform the action; and transmitting the instructions to an internet-of-things device. In some embodiments, the action is selected from a group of reducing outside light in the room, reducing inside light in the room, modifying a sound level on an auditory device associated with the user, and combinations thereof; and the auditory device is selected from a group of hearing aids, earbuds, headphones, and combinations thereof. In some embodiments, the user is associated with an auditory device and the method further includes while the selected media is playing and the selected media is in a different language from a user profile language associated with the user profile, translating words from the selected media from the different language to the user profile language; and transmitting the translated words to the auditory device associated with the user.

In some embodiments, the user profile includes ranked media interests, and the machine-learning model outputs the one or more media items based on selecting top-ranked media interests. In some embodiments, the method further includes registering a user by providing a questionnaire that includes a request for the media interests and viewing preferences and generating a user profile that includes the media interests and the viewing preferences based on answers from the user. In some embodiments, the wireless device is a radar system and determining the user profile associated with the user includes determining a breathing pattern of the user and determining the user profile based on the breathing pattern of the user.

In some embodiments, the wireless device includes a transmitter and a receiver for a wireless protocol selected from a group of Wi-Fi, Bluetooth, Radio Frequency Identification, Near Field Communication, wireless mesh, and combinations thereof; and determining, from the information, the user profile associated with the user includes: detecting, with the wireless device, that an auditory device or a mobile device associated with the user is within proximity of the media player, the auditory device being selected from a group of hearing aids, earbuds, headphones, and combinations thereof; receiving, with the wireless protocol, the information about the user; extracting an identifier from the information; and identifying a match between the identifier and the user profile. In some embodiments, the user is less than eighteen years old and the one or more media items output by the machine-learning model are selected based on the user being less than eighteen years old. In some embodiments, the method further includes responsive to determining the user profile, logging the user into one or more services provided by the media player based on the user profile.

In some embodiments, the machine-learning model includes a query engine and a large language model and the method further includes providing the media interests, a viewing history, and a search request from the user that describes features of a media item to the query engine; combining the search request, the media interests, the viewing history, and a template to form a query; providing the query as input to the large language model; and outputting, with the large language model, the media item that corresponds to query. In some embodiments, the method further includes receiving feedback about the recommendation, and modifying the group profile based on the feedback. In some embodiments, the machine-learning model includes a query engine and a large language model and the method further includes providing the media interests and the request for one or more media items as input to the query engine; combining the media interests and the request for one or more media items with a template to form a query; and providing the query as input to the large language model, wherein the large language model outputs the one or more media items.

In some embodiments, a system comprises one or more processors and logic encoded in one or more non-transitory media for execution by the one or more processors and when executed are operable to: receive, from a wireless device, information about a plurality of users within proximity to a media player; determine, based on the information, user profiles associated with the plurality of users, the profiles each including media interests; generate a group profile that includes the user profiles; provide the group profile and a request for one or more media items as input to a machine-learning model; output, with the machine-learning model, the one or more media items that satisfy the request based on the media interests; and provide a recommendation that includes the one or more media items.

In some embodiments, the each user profile further includes viewing preferences, the logic being further operable to: responsive to a user selecting a media item from the one or more media items in the recommendation, instruct the media player to play selected media item; provide, as input to the machine-learning model, a request to determine an action and for instructions to perform the action to improve a viewing experience in a room; output, with the machine-learning model and based on the viewing preferences, instructions to perform the action; and transmit the instructions to an internet-of-things device. In some embodiments, the action is selected from a group of reducing outside light in the room, reducing inside light in the room, modifying a sound level on an auditory device associated with the user, and combinations thereof; and the auditory device is selected from a group of hearing aids, earbuds, headphones, and combinations thereof. In some embodiments, the user is associated with an auditory device and the logic is further operable to while the selected media is playing and the selected media is in a different language from a user profile language associated with the user profile, translate words from the selected media from the different language to the user profile language; and transmit the translated words to the auditory device associated with the user.

In some embodiments, software encoded in one or more non-transitory computer-readable media for execution by one or more processors and when executed is operable to receive, from a wireless device, information about a plurality of users within proximity to a media player; determine, based on the information, user profiles associated with the plurality of users, the each of the user profiles including media interests; generate a group profile that includes the user profiles; provide the group profile and a request for one or more media items as input to a machine-learning model; output, with the machine-learning model, the one or more media items that satisfy the request based on the media interests; and provide a recommendation that includes the one or more media items.

In some embodiments, each user profile further includes viewing preferences, the logic being further operable to: responsive to a user selecting a media item from the one or more media items in the recommendation, instruct the media player to play selected media item; provide, as input to the machine-learning model, a request to determine an action and for instructions to perform the action to improve a viewing experience in a room; output, with the machine-learning model and based on the viewing preferences, instructions to perform the action; and transmit the instructions to an internet-of-things device. In some embodiments, the action is selected from a group of reducing outside light in the room, reducing inside light in the room, modifying a sound level on an auditory device associated with the user, and combinations thereof; and the auditory device is selected from a group of hearing aids, earbuds, headphones, and combinations thereof.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example network environment according to some embodiments described herein.

FIG. 2 is a block diagram of an example computing device according to some embodiments described herein.

FIG. 3 illustrates example user interfaces of registration questions for specifying demographic information, media interests, and viewing preferences according to some embodiments described herein.

FIG. 4 illustrates an example user interface that includes a recommendation of media items according to some embodiments described herein.

FIG. 5 illustrates an example user interface that includes search results according to some embodiments described herein.

FIG. 6 illustrates an example architecture of a machine-learning model to provide recommendations and search results according to some embodiments described herein.

FIG. 7 is a flowchart of an example method to generate a user profile from answers to a registration questionnaire according to some embodiments described herein.

FIG. 8 is a flowchart of an example method to train a machine-learning model to provide recommendations according to some embodiments described herein.

FIG. 9 is a flowchart of an example method to use a machine-learning model to provide recommendations according to some embodiments described herein.

### DETAILED DESCRIPTION OF EMBODIMENTS

The technology described below advantageously solves the problem of loss of privacy and risks to security by using a wireless device to recognize users that are within proximity to a media player. For example, the wireless device may be a radar system that determines a breathing pattern of a user and transmits the breathing pattern to a media application stored on the media player, where the media application identifies the user by matching the breathing pattern detected by the radar system with a breathing pattern stored on a user profile. In another example, the wireless device includes wireless technology, such as Wi-Fi, Bluetooth, and/or Radio Frequency Identification to identify a user device associated with the user. In some embodiments, the user device is a mobile device, such as a smartphone, or an auditory device, such as hearing aids, earbuds, or headphones.

The media application advantageously recognizes multiple people within proximity to the media player and determines user profiles associated with each user. The multiple people may include different combinations, such as families with parents and children of varying ages, men around the same age, a group of children, etc. The user profile includes media interests, such as preferred genres, preferred actors, etc. The media application generates a group profile that combines the user profiles and that is used by a machine-learning model to output media items that are provided to the users as a recommendation.

Once a user selects a media item for viewing, the machine-learning model may also output instructions to perform an action to improve a viewing experience in a room with the media player. For example, the user profile of one of the users may include a preference to close the curtains while the media item is playing to reduce light that could cause a glare on the media player's screen. The machine-learning model outputs instructions that are transmitted to an internet-of-things device to perform the action.

### Example Environment 100

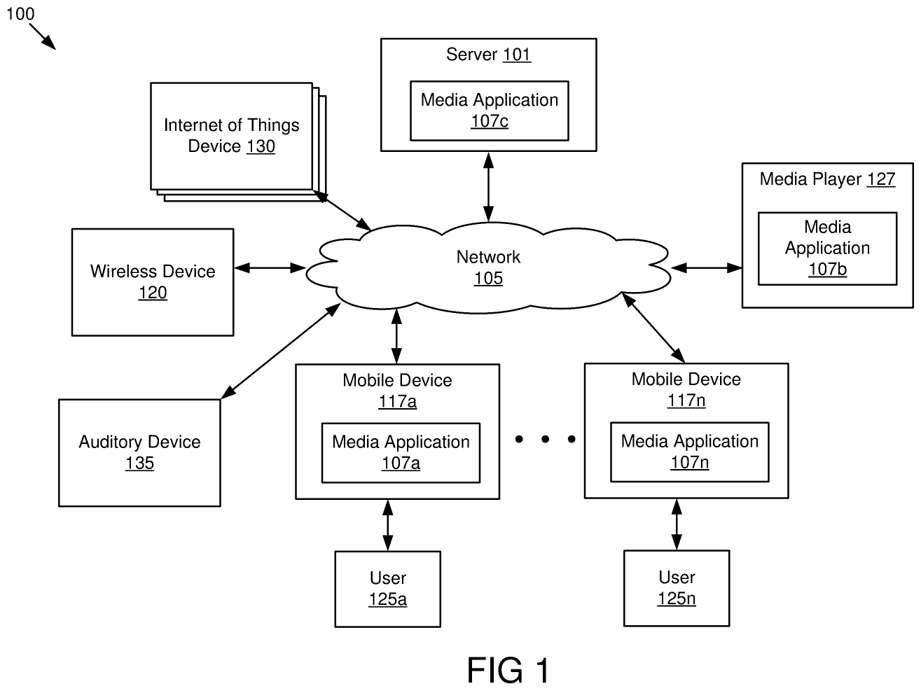

FIG. 1 illustrates a block diagram of an example environment 100. In some embodiments, the environment 100 includes a wireless device 120, mobile devices 117a, 117n, a media player 127, an internet of things (IoT) device 130, an auditory device 135, and a server 101. In some embodiments, the environment 100 may include other servers or devices not shown in FIG. 1. In FIG. 1 and the remaining figures, a letter after a reference number, e.g., “107a,” represents a reference to the element having that particular reference number (e.g., a media application 107a stored on the mobile device 117). A reference number in the text without a following letter, e.g., “107,” represents a general reference to embodiments of the element bearing that reference number (e.g., any media application 107).

The auditory device 135 includes a processor, a memory, a speaker, and network communication hardware. The auditory device 135 may be a hearing aid, earbuds, headphones, or a speaker device. The speaker device may include a standalone speaker, such as a soundbar or a speaker that is part of a device, such as a speaker in a laptop, tablet, phone, etc.

The wireless device 120 includes a processor, a memory, a speaker, and network communication hardware. The network communication hardware may include an antenna and a transmitter. The wireless device 120 may use wireless protocols for Wi-Fi®, Bluetooth®, Radio Frequency Identification (RFID), Near Field Communication (NFC), a wireless mesh, or other wireless technology. In some embodiments, the wireless device 120 includes hardware for a radar system, such as an ultra-wideband (UWB) radar module.

The wireless device 120 detects the presence of people within proximity to the media player 127. For example, the wireless device 120 may determine, based on the radar system, that a user is within proximity to the media player 127. In another example, the wireless device 120 may detect that the user is within proximity to the media player 127 based on receiving a signal, such as using Bluetooth or detecting the auditory device 135. The wireless device 120 transmits information associated with detecting the presence of people to the media application 107b on the media player 127, such as a breathing pattern detected by the radar system, a packet detected by Bluetooth, NFC, RFID, etc. In some embodiments, the wireless device 120 performs detection periodically and updates the media application 107b when a new user is within proximity of the media player 127 or one of the users is no longer within proximity of the media player 127.

The mobile device 117 is a computing device that includes a memory, a hardware processor, and a media application 107b. The mobile device 117 may include a smartphone, a tablet computer, a laptop, a mobile telephone, a wearable device, a head-mounted display, a mobile email device, or another electronic device capable of accessing a network 105 to communicate with one or more of the media player 127, the wireless device 120, and the server 101.

The mobile device 117 may be coupled to the network 105 wirelessly using Wi-Fi®, Bluetooth®, or other wireless technology. The mobile device 117 is used by way of example.

The mobile device 117 includes a display. For example, if the mobile device 117 is a smartphone, the smartphone may include a touch-sensitive display that displays a user interface for a user. The user interface may display options for answering a registration questionnaire, providing feedback on recommendations, etc.

The mobile device 117 includes a media application 107. For example, mobile device 117a includes media application 107a and mobile device 117n includes media application 107n. The mobile device 117 is associated with a user 125. For example, mobile device 117a is associated with user 125a and mobile device 117n is associated with user 125n.

The media application 107a includes logic that is operable to generate a user interface that includes a registration questionnaire and that receives answers to the registration questionnaire. The registration questionnaire may ask the user 125a to provide demographic information, device information, media interests, and viewing preferences, such as whether the user 125a prefers the lights off while media is playing. In some embodiments, the user interface may also receive feedback from a user 125a about recommendations provided by the media application 107b on the media player 127.

The media player 127 includes a processor, a memory, a speaker, a display, and network communication hardware. The media player 127 may include a television, a video player, a virtual reality (VR) headset, an augmented reality (AR) headset, etc. The media player 127 may connect to the network 105 through a wired connection, such as Ethernet, coaxial cable, fiber-optic cable, etc., or a wireless connection, such as Wi-Fi®, Bluetooth®, or other wireless technology.

The media player 127 includes a media application 107b that receives the answers to the questionnaire from the mobile device 117a associated with user 125a and the answers to the questionnaire from the mobile device 117n associated with user 125n. The media application 107b generates a first user profile for user 125a and a second user profile for user 125n.

The media application 107b receives information about users that are within proximity to the media player 127. The media application 107b determines first media interests from a first user profile associated with the first user 125a and second media interests from a second user profile associated with the second user 125n. For example, the first media interests and the second media interests may include each user's 125 top five favorite genres and top three favorite actors.

The media application 107b provides the first user profile, the second user profile, and a request for one or more media items as input to a machine-learning model. The machine-learning model outputs one or more media items that satisfy the request based on the first media interests and the second media interests. For example, the machine-learning model may identify movies that include genres and actors held in common with the first user 125a and the second user 125n, a combination of top-rated genres and actors, or other combinations that are identified as being related in embedded vector space. The media application 107b provides a recommendation that includes the one or more media items.

In some embodiments, if the first user 125a or the second user 125n selects one of the media items in the recommendation, the media player 127 plays the selected media item. The media application 107b provides to the machine-learning model a request to determine an action and for instructions to perform the action to improve a viewing experience. The machine-learning model outputs instructions to perform the action. For example, both the first user 125a and the second user 125n may prefer that the shades be drawn while the television is playing.

The IoT device 130 includes a processor, a memory, and network communication hardware. The IoT device 130 is a piece of hardware, such as a sensor, actuator, gadget, appliance, or machine that is programmed for certain applications. In some embodiments, the media application 107b transmits an instruction to one of the IoT devices 130 that implements the action. For example, the room may include an IoT device 130 with a motor to close the shades in response to receiving the instruction from the media application 107b.

The server 101 includes a processor, a memory, and network communication hardware. In some embodiments, the server 101 is a hardware server. The server 101 is communicatively coupled to the network 105 via a wired connection, such as Ethernet, coaxial cable, fiber-optic cable, etc., or a wireless connection, such as Wi-Fi®, Bluetooth®, or other wireless technology. In some embodiments, the server 101 includes a media application 107c. In some embodiments and with user consent, the media application 107c on the server 101 maintains a copy of user profiles, viewing history, search trends, etc.

In some embodiments, the media application 107c on the server 101 includes the trained machine-learning model and provides information to the media player 127 to take advantage of greater processing power provided by the server 101.

### Example Computing Device 200

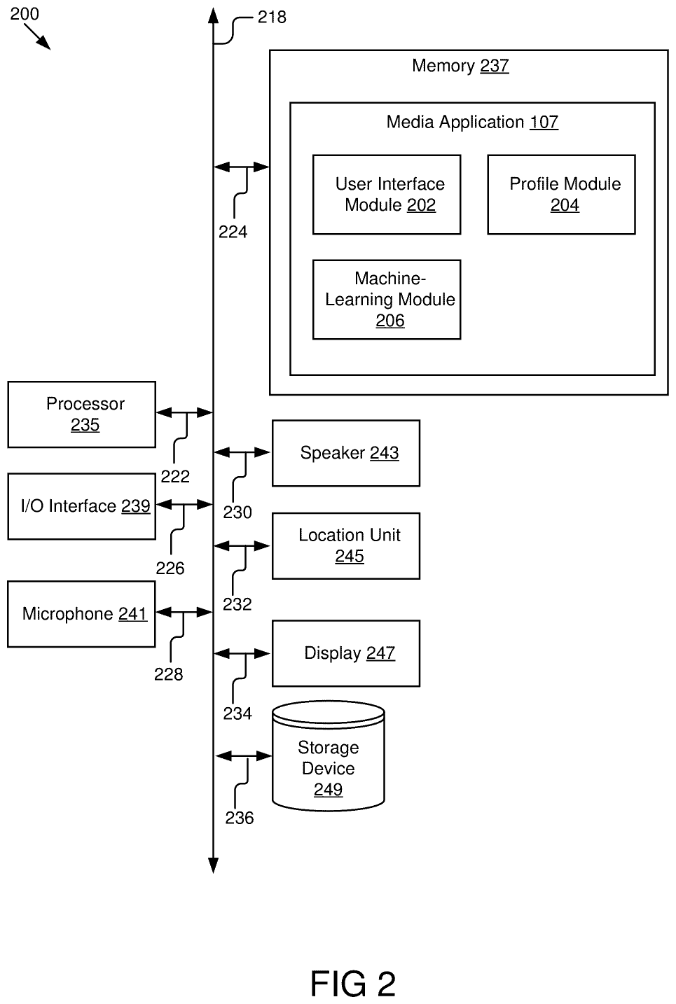

FIG. 2 is a block diagram of an example computing device 200 that may be used to implement one or more features described herein. The computing device 200 can be any suitable computer system or other electronic or hardware device. In some embodiments, the computing device 200 is the media player 127 in FIG. 1. In some embodiments, the computing device 200 is the mobile device 117 in FIG. 1. In some embodiments, some portions of the computing device 200 are performed by one or more of the media player 127, the mobile device 117, and/or the server 101 in FIG. 1.

In some embodiments, computing device 200 includes a processor 235, a memory 237, an Input/Output (I/O) interface 239, a microphone 241, a speaker 243, a location unit 245, a display 247, and a storage device 249. The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the location unit 245 may be coupled to the bus 218 via signal line 232, the display 247 may be coupled to the bus 218 via signal line 234, and the storage device 249 may be coupled to the bus 218 via signal line 236.

The processor 235 can be one or more processors and/or processing circuits to execute program code and control basic operations of the computing device 200. A processor includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, or other systems. A computer may be any processor in communication with a memory.

The memory 237 is typically provided in computing device 200 for access by the processor 235 and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including the media application 107.

The I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., the memory 237 or the storage device 249), and I/O devices can communicate via the I/O interface 239.

In some embodiments, the I/O interface 239 handles communication between the computing device 200 and other devices in a network (e.g., the mobile device 117, the server 101, the wireless device 120, the media player 127, etc.) via a wireless protocol, such as Wi-Fi®, Bluetooth®, Near Field Communication (NFC), Radio Frequency Identification (RFID), Ultra-Wideband (UWB), infrared, radar, etc.

The microphone 241 includes hardware for detecting sounds. For example, the microphone 241 may detect ambient noises, people speaking, music, etc. The speaker 243 produces an audio signal that is heard by the user.

The location unit 245 includes hardware to identify a current location of the computing device 200. The location unit 253 includes one or more of a global positioning system (GPS), Bluetooth®, Wi-Fi®, NFC, RFID, UWB, and infrared.

The display 247 may connect to the I/O interface 239 to display content, e.g., a user interface, and to receive touch (or gesture) input from a user. The display 247 can include any suitable display device such as a liquid crystal display (LCD), light emitting diode (LED), or plasma display screen, television, monitor, touchscreen, or other visual display device.

The storage device 249 stores data related to the media application 107. For example, the storage device 249 may store user profiles generated by the media application 107, training data for a machine-learning model, etc.

Although particular components of the computing device 200 are illustrated, other components may be added or removed.

### Example Media Application 107

The media application 107 includes a user interface module 202, a profile module 204, and a machine-learning module 206. Different modules may be stored on different types of computing devices. For example, a first computing device 200 may be a mobile device 117 that includes the user interface module 202 and a second computing device 200 may be a media player 127 that includes the profile module 204 and the machine-learning module 206.

The user interface module 202 generates graphical data for displaying a user interface. In some embodiments, a user downloads the media application 107 onto a mobile device 117. The user interface module 202 may generate graphical data for displaying a user interface with a registration questionnaire where the answers are used by the profile module 204 to generate a corresponding user profile.

The registration questionnaire may ask the user 125a to provide demographic information (e.g., age, sex, height, languages, etc.). In some embodiments where a user is young, a parent may create a profile for the young user. In some embodiments, the registration questionnaire also asks for device information about devices associated with a user, such as a mobile device 117 and/or an auditory device 135. The information about the devices may include unique identifiers that may be included in packets transmitted to the wireless device 120.

The registration questionnaire may ask the user 125a to provide media interests. In some embodiments, the media interests include favorite genres and favorite actors. In some embodiments, the media interests and/or actors are ranked.

The registration questionnaire may ask the user 125a to provide preferences for actions to occur during viewing of media items. The actions may include changes to curtains, changes to indoor lights, changes to sound levels, closed captioning, etc.

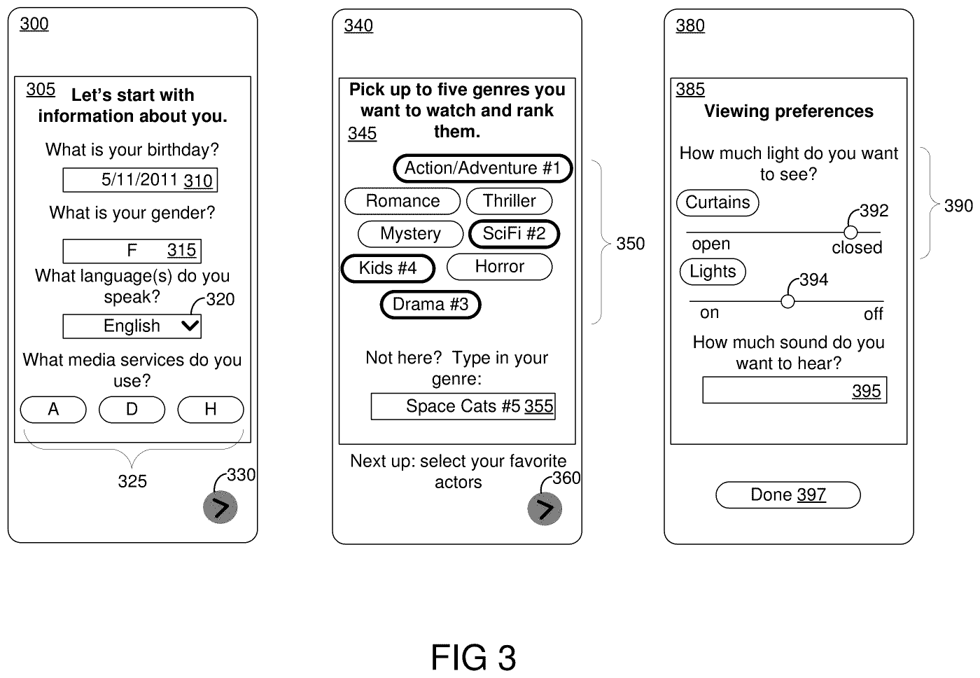

FIG. 3 illustrates example user interfaces 300, 340, 380 of registration questions for specifying demographic information, media interests, and viewing preferences, respectively. The user interfaces 300, 340, 380 may include additional information, information in different orders, less information, etc.

The first user interface 300 includes a request 305 for the user's birthday (or age), gender, one or more languages that they speak, and what media services they use (e.g., different streaming services for media). The user interface 300 includes a text field 310 for inputting the user's age, a text field 315 for inputting the user's gender, a drop-down menu 320 for selecting one or more languages that the user speaks, and buttons 325 for selecting different media services. Other ways of inputting data are possible, such as making all the options into text fields, searchable fields that are prepopulated with the names of streaming services, using audio-to-text translation, etc. Once the user is done, the user may select the next button 330.

The second user interface 340 includes a request 345 for a user to identify five genres that the user wants to watch. The user may select buttons 350 and specify the ranking of the different genres. The user may also use a text field 355 to specify genres that are not present in the prepopulated section of genres. The user may select the next button 360 to advance to a subsequent user interface (not shown) to select the user's favorite actors. The subsequent user interface may include options for specifying the user's favorite actors that include a text field, a drop-down box, prepopulated buttons, etc.

The third user interface 380 includes a request 385 for the user to specify different viewing preferences. For example, the request 385 asks how much light the user wants to see from curtains and lights. The third user interface 380 includes a slider 392 for specifying between curtains that are completely open and completely closed. In this example, the user moves the slider 392 to indicate that the curtains should be mostly closed. The third user interface 380 also includes a slider 394 for specifying between lights that are completely on and completely off. In this example, the user moves the slider 394 so that the lights are about 50% off.

The third user interface 380 also includes a text field 395 for specifying how much sound the user wants to hear. The text field may receive a decibel value, levels (low, medium, high), etc. In some embodiments, the user uses a wireless device 120 that includes hearing aids, earbuds, or headphones and can specify a sound level in the text field 395 for how many decibels (or a level of sound) is transmitted to the wireless device 120. In some embodiments, the wireless device 120 may include speakers, a soundbar, etc. that provide noise for the entire room.

Once the user has answered the questions, the user may select the done button 397. The profile module 204 receives the answers from the user and generates a user profile for the user as discussed in greater detail below. In some embodiments, the profile module 204 updates the age of the user accordingly. As a result, a user that begins as a 14 year old, for example, has less age-restrictions on content after a year has elapsed. The user profile is then used by the machine-learning model to determine media items to recommend to the user. When multiple users are in the same room, the machine-learning model outputs a recommendation for media items based on the combination of people in the room. The user interface module 202 displays the recommendations for media items.

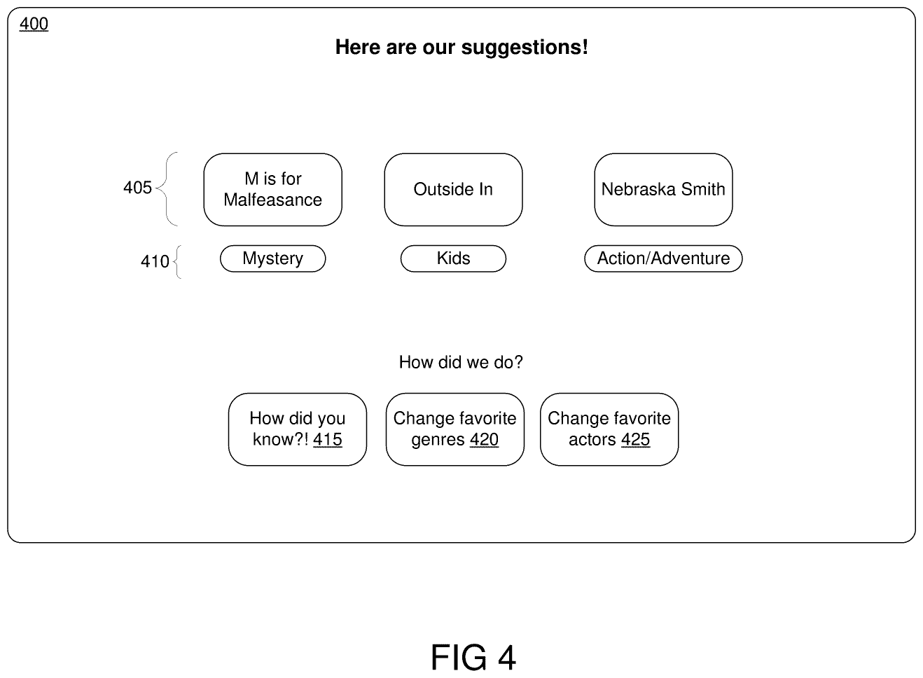

FIG. 4 illustrates an example user interface 400 that includes a recommendation of media items. The user interface 400 lists titles 405 of media items and corresponding genres 410 for the titles. The user interface 400 also includes a request for feedback where the user may select an approval box 415, a genre feedback box 420 to change the list of favorite genres, and an actor feedback box 425 to change the list of favorite actors.

In some embodiments, the user interface module 202 generates a user interface where a user provides search requests for media. If the user interface module 202 is on the mobile device 117, the user interface module 202 may transmit the search request to the media player 127. The media player 127 may also include a user interface module 202 that displays the search results.

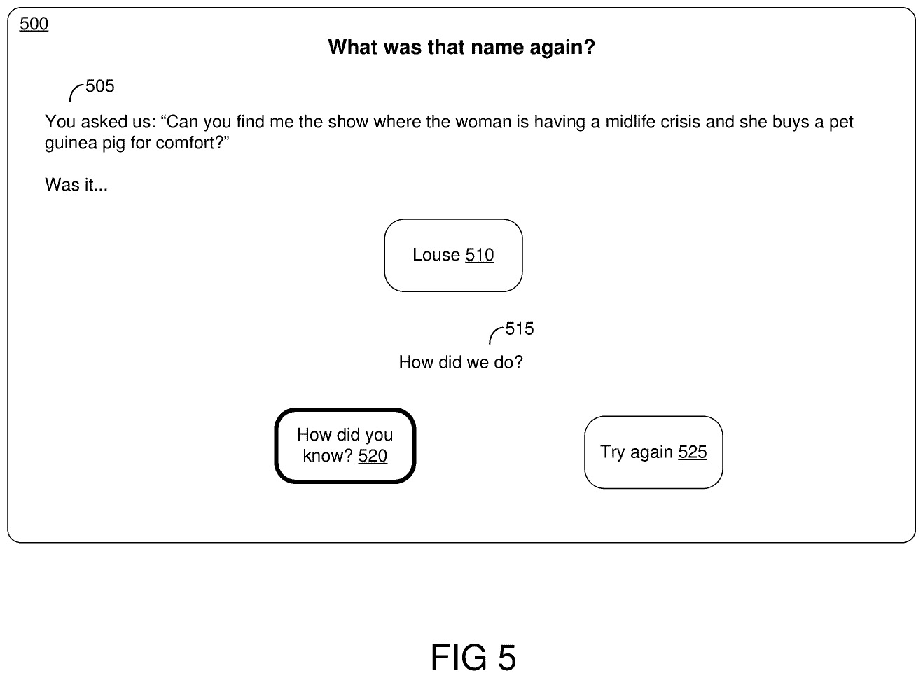

FIG. 5 illustrates an example user interface 500 that includes search results. The user interface 500 includes the search request 505, a search result 510, and a request for feedback 515. Selecting the search result 510 causes the media player 127 to play the selected media. The request for feedback 515 includes a confirmation button 520 to indicate that the search result 510 was correct. In some embodiments, the machine-learning module 206 receives the feedback and recognizes that playing the search result 510 is a signal that the search result 510 was correct. In some embodiments, a user selecting the confirmation button 520 is treated as a stronger signal than the user playing the search result 510 since the user may play a search result even if it is not the correct media item. The user selects the “Try again” button 525 to indicate that the search result 510 is incorrect.

The profile module 204 receives answers to the questionnaire created by the user interface module 202 that includes demographic information, device information, media interests, and viewing preferences. The device information includes identifiers for devices associated with a user, login information for different streaming services on the media player 127, etc. The media interests may include genres that the user enjoys watching, actors that the user is media interested in, etc. In some embodiments, the media interests are ranked. The answers may also include viewing preferences that describe how the user wants to view media items, such as whether the user prefers a dark room, a partially lit room, etc.

The profile module 204 generates a user profile for the user that provided the answers. For example, the user profile may include usernames and passwords for streaming services that are on the media player 127 and accessed by the user.

The profile module 204 updates the user profile based on user actions. For example, the profile module 204 may generate a viewing history section of the user profile and update the viewing history section each time the user watches a media item. The viewing history may include a name of the media item, a genre of the media item, a list of actors in the media item including prominence of the actors in the media item, a length of time that the user viewed the media item, a timestamp for when the viewing began, etc.

In some embodiments, the profile module 204 generates group profiles based on users that are within proximity to the media player 127. The group profile may be a combination of discrete user profiles for each user in the group. For example, a group profile for a first user and a second user may include a first user profile and a second user profile.

The groups include different configurations of people. For example, a family may include a mother, father, teen girl, tween boy, and elementary school girl; a mother, a teen girl, a tween boy, and an elementary school girl; a teen girl, a tween boy, and an elementary school girl; a mother and a teen girl; a father and a teen girl; a mother, tween boy, and elementary school girl; a mother and elementary school girl; a father and elementary school girl; a mother, father, and elementary school girl; two parents; a father, a teen girl, and an elementary school girl; a tween boy and an elementary school girl; etc.

The profile module 204 may update the group profile based on information received from the machine-learning module 206 that is used to recommend media items the next time the same users are within proximity to the media player 127. For example, the profile module 204 may add a group viewing history section to the group profile based on media items that the first user and the second user watch together. The group profile advantageously tracks behavior of the users while in the same group, which may be different than how the users would behave alone or in different combinations.

In some embodiments, the profile module 204 receives feedback about a recommendation generated by the machine-learning model for the group profile. For example, the recommendation may include three media items and a user selects the third media item. The profile module 204 modifies the group profile based on the feedback. Continuing with the example above, the profile module 204 may modify a weight for a genre associated with the third media item to increase the importance of the genre.

In some embodiments, the profile module 204 receives information about one or more users (e.g., a first user and a second user) from the wireless device 120. The information may be about a mobile device 117 or an auditory device 135 associated with the user. The profile module 204 uses the information to determine a user profile associated with the user and transmit the user profile or group profile when multiple users are present to the machine-learning module 206. The identification options below advantageously identify users while maintaining their privacy and increasing their security by using passive information about the users or information about devices associated with the users.

The wireless device 120 may include a transmitter and a receiver for a wireless protocol that includes Wi-Fi, Bluetooth, RFID, NFC, and/or wireless mesh. The profile module 204 detects with the wireless device 120 that an auditory device 135 or a mobile device 117 associated with the user is within proximity of the media player 127. The auditory device 135 may include hearing aids, earbuds, or headphones. The profile module 204 receives, with the wireless protocol, information about the first user. For example, Bluetooth transmits packets of information that includes a unique identifier associated with the auditory device 135 or the mobile device 117. In another example, the mobile device 117 may include an RFID tag that transmits identifying information to the wireless device 120. NFC is part of the RFID family with a range of 20 cm or less, whereas RFID can be used to receive and transmit radio waves over distances of 100 meters or more. The profile module 204 extracts an identifier from the information and identifies a match between the identifier and the user profile associated with the user.

In some embodiments, the wireless device 120 includes a radar system. Radar may be advantageous over other wireless devices 120 because radar has an accuracy of 10-30 cm. The radar system may use Time of Flight (ToF) methodology to determine the position and height of people within proximity to the media player 127 where a beam is transmitted from the radar system and the time it takes the beam to be reflected off a person is used to determine their location and height. In some embodiments, the radar system transmits the height of a person to the profile module 204 and the profile module 204 uses the height to determine an identity of the person.

In some embodiments, the radar system determines breathing patterns for people within proximity to the media player 127 and transmits the breathing patterns to the profile module 204. For example, the radar system may include a UWB radar module and use UWB to determine the breathing patterns. The profile module 204 compares the breathing patterns to breathing patterns that are associated with user profiles and identifies a match. In some embodiments, the height of the person is also transmitted to the profile module 204 and both the breathing pattern and the height of the person are used to identify a matching user profile. Responsive to determining a user profile of a user, the profile module 204 transmits the user profile to the machine-learning module 206 where the user profile is provided as input to the machine-learning model.

In some embodiments, and upon user consent, the wireless device 120 samples audio and the profile module 204 identifies a user based on comparing an audio sample to an audio sample that is part of a user profile to find a match.

In some embodiments, the information received from the wireless device 120 does not correspond to a user profile. The user interface module 202 may provide a user interface that includes an option for registering an unknown user. The user may decline to register and create a user profile, for example, for privacy reasons. The profile module 204 may generate a group profile based on the matched users.

The profile module 204 receives updated information about users from the wireless device 120. For example, the profile module 204 may receive information from the wireless device 120 about a new user that is within proximity of the media player 127. The profile module 204 identifies a corresponding user profile for the new user and transmits the corresponding user profile to the machine-learning module 206. The profile module 204 may also receive information from the wireless device 120 about a user that stops being within proximity of the media player 127. The profile module 204 may transmit a group profile that omits the user profile for the user that left to the machine-learning module 206 so that the machine-learning module 206 can provide relevant recommendations upon request.

The machine-learning module 206 trains a machine-learning model to receive user profiles and/or group profiles that describe media interests as input and output one or more media items that satisfy the media interests included in the user profiles and/or group profiles. In some embodiments, the user profiles also include viewing preferences and the machine-learning module 206 trains the machine-learning model to determine to perform one or more actions related to a room to improve a viewing experience and to instruct one or more IoT devices 130 to perform the one or more actions.

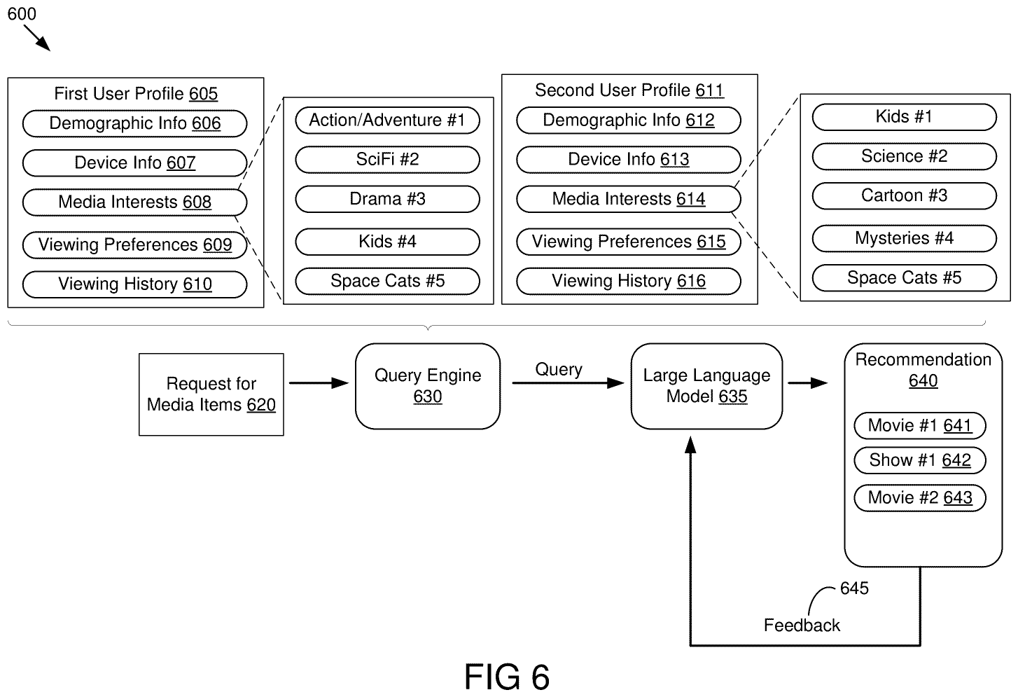

Turning to FIG. 6, an example architecture of a machine-learning model 600 to provide recommendations and search results is illustrated. The machine-learning model receives a group profile that includes user profiles 605, 611 with natural language descriptions that are provided to a query engine 630. In some embodiments, the query engine 630 is a machine-learning model, such as a text-to-text transformer that processes natural language queries by combining different types of information into a template to form a query.

In this example, the query engine 630 receives a group profile that includes a first user profile 605 that includes demographic information 606, device information 607, media interests 608, viewing preferences 609, and a viewing history 610 and a second user profile 611 that includes demographic information 612, device information 613, media interests 614, viewing preferences 615, and viewing history 616. In some embodiments, the user profiles 605, 611 provide a subset of the information, such as the demographic information 606, 612, the media interests 608, 614, the viewing preferences 609, 615, and the viewing history 610, 616.

The media interests 608 for the first user profile 605 include the following ranked genres: action/adventure, science fiction, drama, kids, and space cats. The demographic information 612 for the second user profile 611 identifies the second user as being under 18 (not shown). The device information 613 for the second user profile 611 includes identifiers for devices associated with a user, login information for different streaming services on the media player 127, etc. The media interests 614 for the second user profile 611 include the following ranked genres: kids, science, cartoon, mysteries, and space cats.

The query engine 630 also receives a request for media items 620. The request may be for other information as well, such as a request for search results, a request for an action based on viewing preferences, a request for a translation of audio or text in a media item, etc.

The query engine 630 combines the text included in the media interests 608, 614 with the request for media items 620. The media interests 608, 614 and the request for media items 620 may be combined with a template to form a query. For example, the template may include: “The <first user> has the following <media interests 608: action/adventure, science fiction, drama, kids, and space cats> and has viewed these media items: <viewing history 610>. The <second user> has the following <media interests 614: kids, science, cartoon, mysteries, space cats> and has viewed these media items: <viewing history 616>. Based on this information, your task is to provide a recommendation for <three> media items for the <first user> and the <second user> to watch together at 1:05 pm?” The time may be specified because users may have different viewing habits depending on the time of day. In embodiments where the group profile has been used before and the users have viewed media items together, the query may additionally including a group viewing history.

In some embodiments, the query engine 630 includes weights or emphasis for the different media interests 608, 614 based on their ranking. For example, the template may include: “The <first user> has the following <media interests 608: action/adventure is ranked first, science fiction is ranked second, drama is ranked third, kids is ranked fourth, and space cats is ranked fifth> and has viewed these media items: <viewing history 610>. The <second user> has the following <media interests 614: kids is ranked first, science is ranked second, cartoon is ranked third, mysteries is ranked fourth, space cats is ranked fifth> and has viewed these media items: <viewing history 616>. Based on this information, your task is to provide a recommendation for <three> media items for the <first user> and the <second user> to watch together at 1:05 pm?”

Large language models are built on natural language text. The large language model 635 may include learnable weights that are attached to a model layer. The learnable weights may use key and query in self-attention layers of the large language model 635. The loss function may be a cross-entropy loss function for maximizing the likelihood of a desired system response for a given request for media items 620. In some embodiments, the large language model 635 is fine-tuned by adjusting hyperparameters, such as the number of epochs to train the model for, the batch size (i.e., the number of examples used in a single training pass), the learning rate at which the model weights are updated, and how much the model learns from prompt tokens versus completion tokens.

The large language model 635 is trained to associate the query with corresponding media items. As a result, when the large language model 635 receives the query, the large language model 635 associated with query different media items 641, 642, 643. The large language model 635 outputs a recommendation 640 that includes different media items 641, 642, 643. The media items 641, 642, 643 reflect the media interests 608, 614 for both the first user profile 605 and the second user profile 611.

In some embodiments, the media items 641, 642, 643 are selected based on the top-ranked media interests 608, such that for genres action/adventure and kids are selected before science fiction and science; drama and cartoon are selected before mysteries and space cats, etc.

In some embodiments, the query also includes an age restriction. Continuing with the example above, since the user associated with the second user profile 611 is under 18, the media items 641, 642, 643 are selected based on the user being under 18. For example, if the user is 13, the media items 641, 642, 643 may be restricted to content with a rating of G, PG, and PG-13. If the user is 17, the media items 641, 642, 643 may be restricted to content with a rating of G, PG, PG-13 and R, but not NC-17. In some embodiments, the second user profile 611 may specify the type of content that should be excluded, such as sexual content, but not swearing and the media items 641, 642, 643 are selected accordingly.

The large language model 635 may receive feedback 645 that is used to refine the large language model 635. For example, a user may select one of the recommendations 640, which reinforces the success of the large language model 635 or the user may ask for different recommendations, which suggests that the recommendation 640 was unsuccessful.

In some embodiments, a user may select a media item that is a series where multiple users associated with the group profile are at different locations within the series. For example, a first user may have watched all of the first season and a second user may have watched 50% of the first season. The machine-learning model 600 may play the series at the newest or oldest unwatched episode, instruct the user interface module 202 to ask the users whether they prefer starting at the newest or oldest unwatched episode, or the machine-learning model 600 plays the series based upon a user preference specified during registration.

In some embodiments, the machine-learning model 600 is also trained to determine to perform an action. For example, if a user selects movie #1, the large language model 635 may instruct a media player 127 to play the selected media item and determine to perform an action related to a room to improve a viewing experience. The action may include reducing outside light in the room, reducing inside light in the room, modifying a sound level on an auditory device 135, providing closed captioning, etc. The action may be a combination of both viewing preferences 609, 615. For example, the action may be turning down the lights partially as a compromise between a first user that likes the lights on and a second user that likes the lights completely off.

The query engine 630 may receive a group profile, a request to generate instructions for performing an action, and a template to create a query. For example, the query may be: “The <first user> has the following <viewing preferences 609>. The <second user> has the following <viewing preferences 615>. Based on this information, your task is to provide <instructions to perform an action> that satisfies the <viewing preferences 609, 615>?” In some embodiments, the machine-learning module 206 transmits the instructions to an internet-of-things device 130 to perform the action. For example, the internet-of-things device 130 may be a smart device that turns down the lights in response to instructions.

In some embodiments, the machine-learning model 600 is also trained to perform a search based on a description of a media item. The query engine 630 may receive media interests, a viewing history, and a search request from a user that describes features of a media item. For example, the features may include a plot, a list of actors, a year the media item was made, etc. In some embodiments, the query engine also receives a list of known or preferred topics and/or subjects. The query engine 630 combines the search request, the first media interests, the viewing history, a template to form a query, and possibly the list of known or preferred topics and/or subjects. The query is provided to the large language model 635, which outputs the media item that corresponds to the query.

In some embodiments, the large language model 635 performs translation between languages. For example, the first user profile 605 includes demographic information 606 including that the first user speaks Spanish. If the selected media is in English, the large language model 635 may perform translation and transmit translated audio to an auditory device 135 associated with the first user and described by the device information 607 in the first user profile 605.

In some embodiments, the large language model 635 logs a user into one or more services provided by the media player 127. In some embodiments, the large language model 635 logs all users that were detected within proximity to the media player 127 into the one or more services provided by the media player 127 so that the viewing history 610, 616 is updated for all users. In some embodiments, the large language model 635 logs a user into a service that is associated with selected media.

### Example Methods

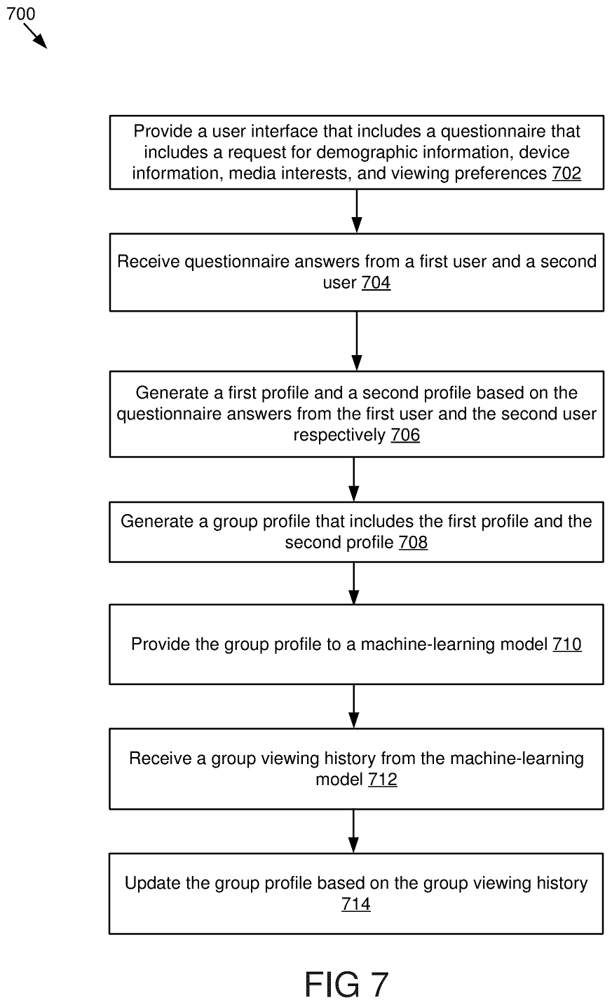

FIG. 7 is a flowchart of an example method 700 to generate a user profile from answers to a registration questionnaire. The method 700 is implemented by one or more computing devices 200 as described with reference to FIG. 2. The one or more computing devices 200 include the auditory device 135, the mobile device 117, and/or the server 101 as illustrated in FIG. 1.

The method 700 may start with block 702. At block 702, a user interface is provided that includes a questionnaire that includes a request for demographic information, device information, media interests, and viewing preferences. Block 702 may be followed by block 704.

At block 704, questionnaire answers are received from a first user and a second user. Block 704 may be followed by block 706.

At block 706, a first profile and a second profile are generated based on the questionnaire answers from the first user and the second user, respectively. Block 706 may be followed by block 708.

At block 708, a group profile is generated that includes the first profile and the second profile. Block 708 may be followed by block 710.

At block 710, the group profile is provided to a machine-learning model. Block 710 may be followed by block 712.

At block 712, a group viewing history is received from the machine-learning model. Block 712 may be followed by block 714.

At block 714, the group profile is updated based on the group viewing history.

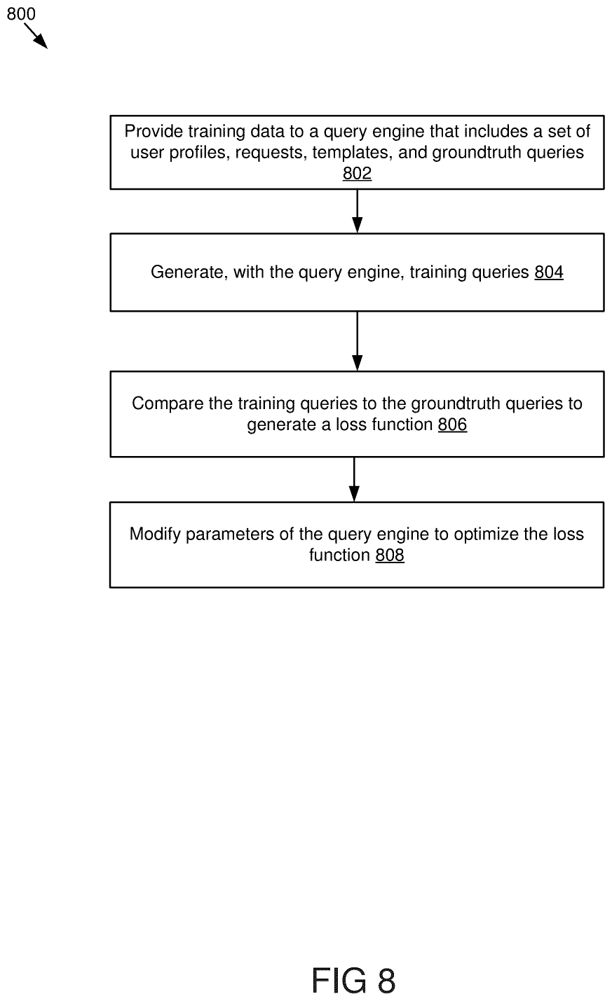

FIG. 8 is a flowchart of an example method 800 to train a machine-learning model to provide recommendations according to some embodiments described herein. The method 800 is implemented by one or more computing devices 200 as described with reference to FIG. 2. The one or more computing devices 200 include the auditory device 135, the mobile device 117, and/or the server 101 as illustrated in FIG. 1.

The method 800 may start with block 802. At block 802, training data is provided to a query engine that includes a set of user profiles, requests, templates, and groundtruth queries. Block 802 may be followed by block 804.

At block 804, the query engine generates training queries. For example, the training queries are generated by inserting the user profiles and requests into the templates. Block 804 may be followed by block 806.

At block 806, the training queries are compared to the groundtruth queries to generate a loss function. Block 806 may be followed by block 808.

At block 808, parameters of the query engine are modified to optimize the loss function.

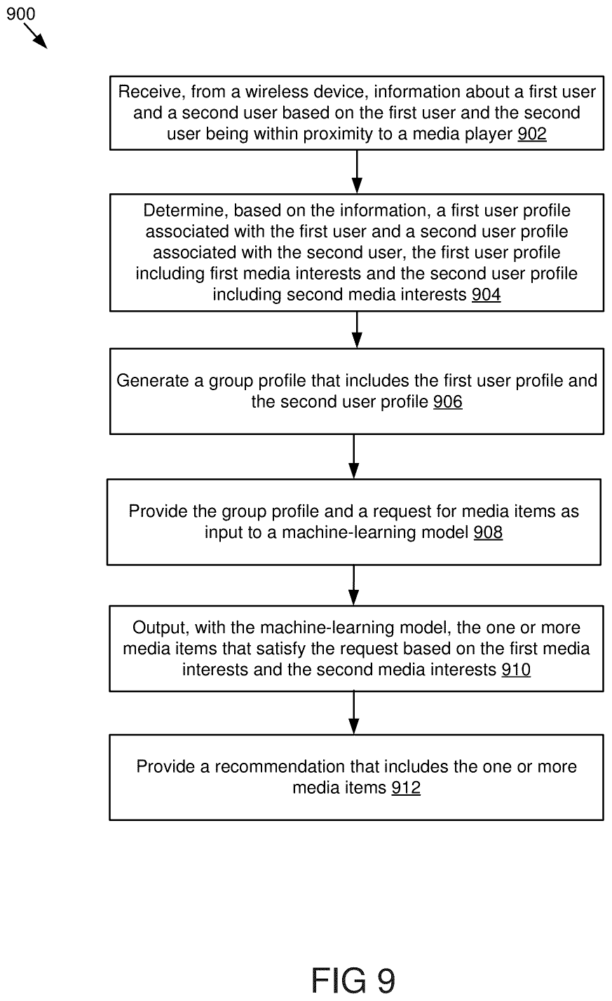

FIG. 9 is a flowchart of an example method 900 to use a machine-learning model to provide recommendations according to some embodiments described herein. The method 900 is implemented by one or more computing devices 200 as described with reference to FIG. 2. The one or more computing devices 200 include the auditory device 135, the mobile device 117, and/or the server 101 as illustrated in FIG. 1.

The method 900 may start with block 902. At block 902, information is received from a wireless device about a first user and a second user based on the first user and the second user being within proximity to a media player. Block 902 may be followed by block 904.

At block 904, based on the information, a first user profile associated with the first user and a second user profile associated with the second user are determined, the first user profile including first media interests and the second user profile including second media interests. Block 904 may be followed by block 906.

At block 906, a group profile is generated that includes the first user profile and the second user profile. Block 906 may be followed by block 908.

At block 908, the group profile and a request for media items are provided as input to a machine-learning model. Block 908 may be followed by block 910.

At block 910, the machine-learning model outputs the one or more media items that satisfy the request based on the first media interests and the second media interests. Block 910 may be followed by block 912.

At block 912, a recommendation that includes the one or more media items is provided.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end mobile devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A computer-implemented method comprising:
receiving, from a wireless device, information about a plurality of users within proximity to a media player;
determining, based on the information, user profiles associated with the plurality of users, the profiles each including media interests;
generating a group profile that includes the profiles;
providing the group profile and a request for one or more media items as input to a machine-learning model;
outputting, with the machine-learning model, the one or more media items that satisfy the request based on the media interests; and
providing a recommendation that includes the one or more media items.

2. The method of claim 1, wherein each user profile further includes viewing preferences, the method further comprising:
responsive to a user of the plurality of users selecting a media item from the one or more media items in the recommendation, instructing the media player to play a selected media item;
providing, as input to the machine-learning model, a request to determine an action and for instructions to perform the action to improve a viewing experience in a room;
outputting, with the machine-learning model and based on the viewing preferences, instructions to perform the action; and
transmitting the instructions to an internet-of-things device.

3. The method of claim 2, wherein:
the action is selected from a group of reducing outside light in the room, reducing inside light in the room, modifying a sound level on an auditory device associated with the user, and combinations thereof; and
the auditory device is selected from a group of hearing aids, earbuds, headphones, and combinations thereof.

4. The method of claim 2, wherein the user is associated with an auditory device, the method further comprising:
while the selected media is playing and the selected media is in a different language from a user profile language associated with the a user profile, translating words from the selected media from the different language to the user profile language; and
transmitting the translated words to the auditory device associated with the user.

5. The method of claim 1, wherein the user profiles include ranked media interests and the machine-learning model outputs the one or more media items based on selecting top-ranked media interests from the user profiles.

6. The method of claim 1, further comprising:
registering a user by:
providing a questionnaire that includes a request for the media interests and viewing preferences; and
generating a user profile that includes the media interests and viewing preferences based on answers from the user.

7. The method of claim 1, wherein the wireless device is a radar system and determining a user profile associated with a user includes:
determining a breathing pattern of the user; and
determining the user profile based on the breathing pattern of the user.

8. The method of claim 1, wherein:
the wireless device includes a transmitter and a receiver for a wireless protocol selected from a group of Wi-Fi, Bluetooth, Radio Frequency Identification, Near Field Communication, wireless mesh, and combinations thereof; and
determining, from the information, a user profile associated with a user includes:
detecting, with the wireless device, that an auditory device or a mobile device associated with the user is within proximity of the media player, the auditory device being selected from a group of hearing aids, earbuds, headphones, and combinations thereof;
receiving, with the wireless protocol, the information about the user;
extracting an identifier from the information; and
identifying a match between the identifier and the user profile.

9. The method of claim 1, wherein a user of the plurality of users is less than eighteen years old and the one or more media items output by the machine-learning model are selected based on the user being less than eighteen years old.

10. The method of claim 1, further comprising:
responsive to determining the user profiles, logging a user into one or more services provided by the media player based on the user profile.

11. The method of claim 1, wherein the machine-learning model includes a query engine and a large language model, the method further comprising:
providing the media interests, a viewing history, and a search request from a user that describes features of a media item to the query engine;
combining the search request, the media interests, the viewing history, and a template to form a query;
providing the query as input to the large language model; and
outputting, with the large language model, the media item that corresponds to query.

12. The method of claim 1, further comprising:
receiving feedback about the recommendation; and
modifying the group profile based on the feedback.

13. The method of claim 1, wherein the machine-learning model includes a query engine and a large language model, the method further comprising:
providing the media interests and the request for one or more media items as input to the query engine;
combining the media interests and the request for one or more media items with a template to form a query; and
providing the query as input to the large language model, wherein the large language model outputs the one or more media items.

14. A system comprising:
one or more processors; and
logic encoded in one or more non-transitory media for execution by the one or more processors and when executed are operable to:
receive, from a wireless device, information about a plurality of users within proximity to a media player;
determine, based on the information, user profiles associated with the plurality of users, the profiles each including media interests;
generate a group profile that includes the profiles;
provide the group profile and a request for one or more media items as input to a machine-learning model;
output, with the machine-learning model, the one or more media items that satisfy the request based on the media interests; and
provide a recommendation that includes the one or more media items.

15. The system of claim 13, wherein each profile further includes viewing preferences, the logic being further operable to:
responsive to a user selecting a media item from the one or more media items in the recommendation, instruct the media player to play selected media item;
provide, as input to the machine-learning model, a request to determine an action and for instructions to perform the action to improve a viewing experience in a room;
output, with the machine-learning model and based on the viewing preferences, instructions to perform the action; and
transmit the instructions to an internet-of-things device.

16. The system of claim 15, wherein:
the action is selected from a group of reducing outside light in the room, reducing inside light in the room, modifying a sound level on an auditory device associated with the user, and combinations thereof; and
the auditory device is selected from a group of hearing aids, earbuds, headphones, and combinations thereof.

17. The system of claim 15, wherein the user is associated with an auditory device, the logic further operable to:
while the selected media is playing and the selected media is in a different language from a user profile language associated with a user profile, translate words from the selected media from the different language to the user profile language; and
transmit the translated words to the auditory device associated with the user.

18. Software encoded in one or more non-transitory computer-readable media for execution by one or more processors and when executed is operable to:
receive, from a wireless device, information about a plurality of users within proximity to a media player;
determine, based on the information, user profiles associated with the plurality of users, the profiles each including media interests;
generate a group profile that includes the user profiles;
provide the group profile and a request for one or more media items as input to a machine-learning model;
output, with the machine-learning model, the one or more media items that satisfy the request based on the media interests; and
provide a recommendation that includes the one or more media items.

19. The software of claim 18, wherein each profile further includes viewing preferences, the logic being further operable to:
responsive to a user of the plurality of users selecting a media item from the one or more media items in the recommendation, instruct the media player to play selected media item;
provide, as input to the machine-learning model, a request to determine an action and for instructions to perform the action to improve a viewing experience in a room;
output, with the machine-learning model and based on the viewing preferences, instructions to perform the action; and
transmit the instructions to an internet-of-things device.

20. The software of claim 19, wherein:
the action is selected from a group of reducing outside light in the room, reducing inside light in the room, modifying a sound level on an auditory device associated with the user, and combinations thereof; and
the auditory device is selected from a group of hearing aids, earbuds, headphones, and combinations thereof.
